(19) United States
(12) Patent Application Publication
(10) Pub. No.: US 2025/0039806 A1
(43) Pub. Date: Jan. 30, 2025

(54) MAXIMUM PERMISSIBLE EXPOSURE (MPE) CONTROL FOR SIMULTANEOUS UL TRANSMISSION WITH MULTI-PANELS (STXMP)

(71) Applicant: Apple Inc., Cupertino, CA (US)

(72) Inventors: Xiang CHEN, Campbell, CA (US); Yang TANG, San Jose, CA (US); Jie CUI, San Jose, CA (US); Haitong SUN, Cupertino, CA (US); Yuexia SONG, Beijing (CN); Qiming LI, Beijing (CN); Dawei ZHANG, Saratoga, CA (US)

(73) Assignee: Apple Inc., Cupertino, CA (US)

(21) Appl. No.: 18/754,416

(22) Filed: Jun. 26, 2024

Related U.S. Application Data
(60) Provisional application No. 63/516,309, filed on Jul. 28, 2023.

(51) Int. Cl. H04W 52/36; H04W 24/10; H04W 52/26; H04W 52/28

(52) U.S. Cl. CPC H04W 52/362; H04W 24/10; H04W 52/26; H04W 52/283; H04W 52/365

(57) ABSTRACT

Aspects are described for a user equipment (UE) comprising a first antenna panel and a second antenna panel to enable wireless communication with a first base station and a second base station respectively and a processor communicatively coupled to the first antenna panel and the second antenna panel. The processor is configured to determine that a total transmission power of the first antenna panel and the second antenna panel is greater than a threshold and determine a first back-off value for the first antenna panel and a second back-off value for the second antenna panel. The processor is further configured to generate a report that indicates the first back-off value and the second back-off value and transmit, via the first antenna panel or the second antenna panel, the report.

### CROSS REFERENCES

This application claims the benefit of U.S. Provisional Application No. 63/516,309 filed Jul. 28, 2023, titled “MAXIMUM PERMISSIBLE EXPOSURE (MPE) CONTROL FOR SIMULTANEOUS UL TRANSMISSION WITH MULTI-PANELS (STXMP),” the content of which is herein incorporated by reference in its entirety.

### BACKGROUND

### Field

The described aspects generally relate to transmission power control of a user equipment (UE).

### Summary

Some aspects of this disclosure relate to systems, apparatuses, and methods for transmission power control of a UE. For example, the systems, the apparatuses, and the methods are provided for reducing transmission power of multiple antenna panels and reporting the transmission power reduction to a network.

Some aspects of this disclosure relate to a user equipment (UE) comprising a first antenna panel and a second antenna panel to enable wireless communication with a first base station and a second base station respectively and a processor communicatively coupled to the first antenna panel and the second antenna panel. The processor is configured to determine that a total transmission power of the first antenna panel and the second antenna panel is greater than a threshold and determine a first back-off value for the first antenna panel and a second back-off value for the second antenna panel. The processor is further configured to generate a report that indicates the first back-off value and the second back-off value and transmit, via the first antenna panel or the second antenna panel, the report.

Some aspects of this disclosure relate to a method of operating a UE. The method comprises determining that a total transmission power of a first antenna panel and a second antenna panel of the UE is greater than a threshold and determining a first back-off value for the first antenna panel and a second back-off value for the second antenna panel. The method further comprises generating a report that indicates the first back-off value and the second back-off value and transmitting, via the first antenna panel or the second antenna panel, the report.

Some aspects of this disclosure relate to a non-transitory computer-readable medium (CRM) comprising instructions to, upon execution of the instructions by one or more processors of a UE, cause the UE to perform operations. The operations comprise determining that a total transmission power of a first antenna panel and a second antenna panel of the UE is greater than a threshold and determining a first back-off value for the first antenna panel and a second back-off value for the second antenna panel. The operations further comprise generating a report that indicates the first back-off value and the second back-off value and transmitting, via the first antenna panel or the second antenna panel, the report.

This Summary is provided merely for the purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing transmission power control of a UE, according to some aspects of the disclosure.

FIG. 2 illustrates a block diagram of an example system of an electronic device for implementing the transmission power control, according to some aspects of the disclosure.

FIG. 3 illustrates an example method of adjusting and reporting the transmission power, according to aspects of the disclosure.

FIG. 4 illustrates an example method of assigning power reduction to multiple panels of the UE, according to aspects of the disclosure.

FIG. 5 is an example computer system for implementing some aspects of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to systems, apparatuses, and methods for transmission power control of a UE. For example, the systems, the apparatuses, and the methods are provided for reducing transmission power of multiple antenna panels and reporting the transmission power reduction to a network.

In some aspects, wireless devices, including a UE, are subject to transmission power restrictions. The restrictions can be set by the network in various situations. For example, when the UE is located in a crowded area where a large number of wireless devices are present, the network may configure the UE to reduce its transmission power or keep its transmission power below a threshold. This is because transmission signals from the UE can become interference to other wireless devices. To avoid jamming each other's signals, the network may restrict transmission power of all wireless devices in the crowded area. For another example, when the UE is in an indoor environment, the network may also configure the UE to restrict its transmission power to maintain its radiation at an acceptable level. Although the radiation from the UE may be generally small and safe for humans, the UE may increase its transmission power when it is indoors to maintain the connection with a base station. Specifically, radio signals between the UE and the base station may experience more severe propagation and degradation when the UE is inside a building. Thus, to maintain the same link quality, the UE may increase its transmission power so that the base station receives signals from the UE with the same signal strength and/or signal-to-noise ratio (SNR) when the UE moves from an outdoor environment to an indoor environment. In such a case, the network may configure the UE to refrain from increasing its transmission power or set a limit on the transmission power so that it does not produce additional radiation to people in the building or surrounding the UE.

In some aspects, the UE is subject to transmission power restrictions set by a standard, such as a Third Generation Partnership Project (3GPP) standard. For example, the standard can set a total effective isotropic radiated power (EIRP). In such a case, the UE's transmission power in a certain direction is limited. For another example, the standard can set a total radiated power limit in all directions. In either case, when the UE determines that its transmission power exceeds the transmission power restrictions, the UE can reduce its transmission power to comply with the restrictions. For yet another example, the UE may be subject to regulatory requirements, such as a maximum permissible exposure (MPE) requirement, which is measured in terms of power density (PD) and is specified in units of Watts/m² or mW/cm². When the transmission power of the UE exceeds the MPE in any direction, the UE needs to reduce its transmission power.

In some aspects, the UE may include multiple antenna panels. For example, the UE may include a first antenna panel and a second antenna panel. Both antenna panels may be restricted by the transmission power restrictions. For example, when the first antenna panel and the second antenna panel at least partially overlap with the restricted direction, they are subject to the total EIRP restriction. In other words, when the total transmission power of the first and the second antenna panels are higher than the total EIRP restriction in the restricted direction, the UE needs to reduce its transmission power. For another example, the transmission power of both the first antenna panel and the second antenna panel can be subjected to the total radiated power limit regardless of their directions. Specifically, the first antenna panel and the second antenna panel may not overlap. Nevertheless, the total radiated power of the first and the second antenna panels is restricted by the total radiated power limit. For yet another example, when the first and the second antenna panels overlap in a common direction, the total transmission power of the UE in the common direction is restricted by the MPE requirement.

In some aspects, the UE can reduce its total transmission power when the UE determines that its total transmission power exceeds any of the restrictions discussed above. However, the amount of transmission power to be reduced for each of the first and the second antenna panels is still an open question. In other words, the UE needs to determine how much transmission power to be reduced for each of the first and the second antenna panels when they both contribute to the total transmission power that exceeds a restriction. In some aspects, the UE can reduce the transmission power of both the first and the second antenna panels equally. In other aspects, the power reduction can be distributed amongst the first and the second antenna panels unequally. For example, the first antenna panel may be more important than the second antenna panel. In such a case, the UE reduces less power in the first antenna panel compared with the second antenna panel. For another example, the first antenna panel may contribute more than the second antenna panel in the total transmission power. In such a case, the UE can reduce more power in the first antenna panel compared with the second antenna panel.

In some aspects, the UE can report the power reductions of the first and the second antenna panels to the network so that the network is aware of the power restriction situation and power reduction operations the UE takes. In some aspects, the UE can report the power reductions in a format of a power headroom report (PHR). The UE can report the power reductions of the first and the second antenna panels in a combined PHR or separate PHRs. In addition, the UE can report the power reduction promptly when determining that the total transmission power exceeds a restriction.

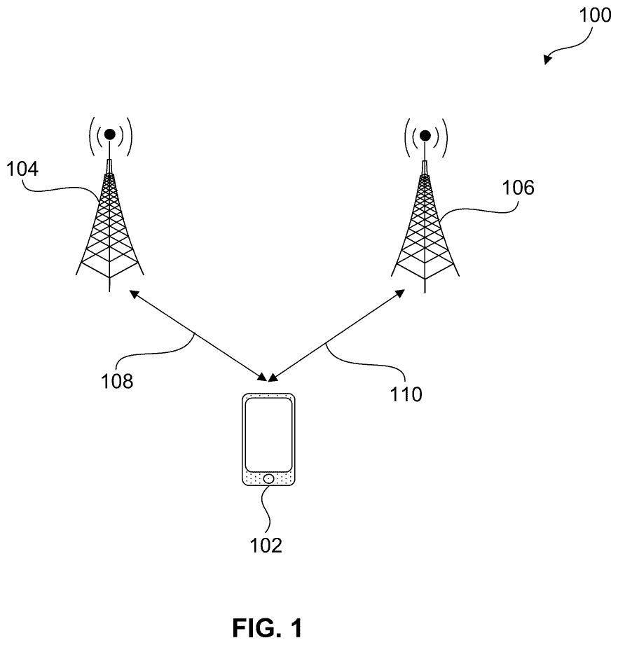

FIG. 1 illustrates an example system 100 implementing transmission power control of a UE, according to some aspects of the disclosure. The example system 100 is provided for the purpose of illustration only and does not limit the disclosed aspects. The example system 100 may include, but is not limited to, a UE 102 and base stations 104 and 106. The UE 102 may be implemented as electronic devices configured to operate based on a wide variety of wireless communication techniques. These techniques may include, but are not limited to, techniques based on 3rd Generation Partnership Project (3GPP) standards. For example, the UE 102 may be configured to operate using one or more 3GPP releases, such as Release 15 (Rel-15), Release 16 (Rel-16), Release 17 (Rel-17), Release 18 (Rel-18), or other 3GPP releases. The UE 102 may include, but is not limited to, wireless communication devices, smartphones, laptops, desktops, tablets, personal assistants, monitors, televisions, wearable devices, Internet of Things (IoT) devices, vehicle communication devices, and the like. The base stations 104 and 106 may include one or more nodes configured to operate based on a wide variety of wireless communication techniques such as, but not limited to, techniques based on the 3GPP standards. For example, the base station 104 may include nodes configured to operate using Rel-15, Rel-16, Rel-17, Rel-18, or other 3GPP releases. The base station 104 may include, but not limited to, NodeBs, evolved NodeBs (eNodeBs), next generation NodeBs (gNBs), new radio base stations (NR BSs), access points (APs), remote radio heads, relay stations, transmission/reception points (TRPs), and others.

In some aspects, the UE 102 can communicate with both the base stations 104 and 106 via communication links 108 and 110 respectively. The UE 102 may include one or more antenna panels. For example, the UE 102 can include a first antenna panel that is configured to transmit to and/or receive from the base station 104. The UE 102 can also include a second antenna panel that is configured to transmit to and/or receive from the base station 106. In some aspects, the first and the second antenna panels can be associated with transmission directions. For example, the first and the second antenna panels can form a first beam and a second beam respectively. Transmission angles of the first beam and the second beam may or may not overlap. Specifically, the first beam can include a first main lobe and a first set of side lobes. The second beam can include a second main lobe and a second set of side lobes. The first main lobe and the second main lobe may partially overlap or fully overlap in a direction. In addition, the first main lobe may partially or fully overlap with the second set of side lobes and the second main lobe may partially or fully overlap with the first set of side lobes.

In some aspects, the UE 102 may be subject to transmission power restrictions. As discussed above, the UE 102 can be subject to a total EIRP (i.e., the aggregated EIRP of all beams over all panels in a direction) restriction, a total radiated power (radiated power summed over all directions) restriction, and/or a MPE restriction. Thus, the UE 102 may need to adjust its transmission power of the first and the second antenna panels in certain situations. For example, the total EIRP restriction may be associated with a first direction. Thus, the transmission power of the UE 102 in the first direction cannot exceed an EIRP threshold. In some aspects, the first beam and the second beam may overlap in the first direction. In such a case, signals transmitted from both the first antenna panel and the second antenna panel are subject to the total EIRP restriction. In addition, the UE 102 can transmit via the first antenna panel and the second antenna panel simultaneously to the base stations 104 and 106 respectively. Thus, when the UE 102 determines that the total EIRP restriction is reached or exceeded, the UE 102 may reduce transmission power of one or both of the first and the second antenna panels. Similarly, the UE 102 may also need to reduce transmission power of one or both of the first and the second antenna panels based on other restrictions, e.g., the total radiated power restriction in all directions and the MPE restriction.

In some aspects, the UE 102 can report its power reduction to the network. For example, the UE 102 can connect and communicate with the network via the base station 104 or the base station 106. Thus, the UE 102 can transmit a report to the base station 104 or the base station 106. In some aspects, the UE 102 may reduce transmission power of both the first and the second antenna panels. Thus, the UE 102 can report the transmission power reduction separately or together. For example, the UE 102 can transmit a first report to the base station 104 via the communication link 108 using the first antenna panel, wherein the first report includes the power reduction of the first antenna panel. The UE 102 can also transmit a second report to base station 106 via the communication link 110 using the second antenna panel, wherein the second report includes power reduction of the second antenna panel. In another example, the UE 102 can transmit a combined report that includes the power reductions of the first and the second antenna panels. The UE 102 can transmit the combined report via the communication link 108 using the first antenna panel or via the communication link 110 using the second antenna panel or via both the first antenna panel and the second antenna panel.

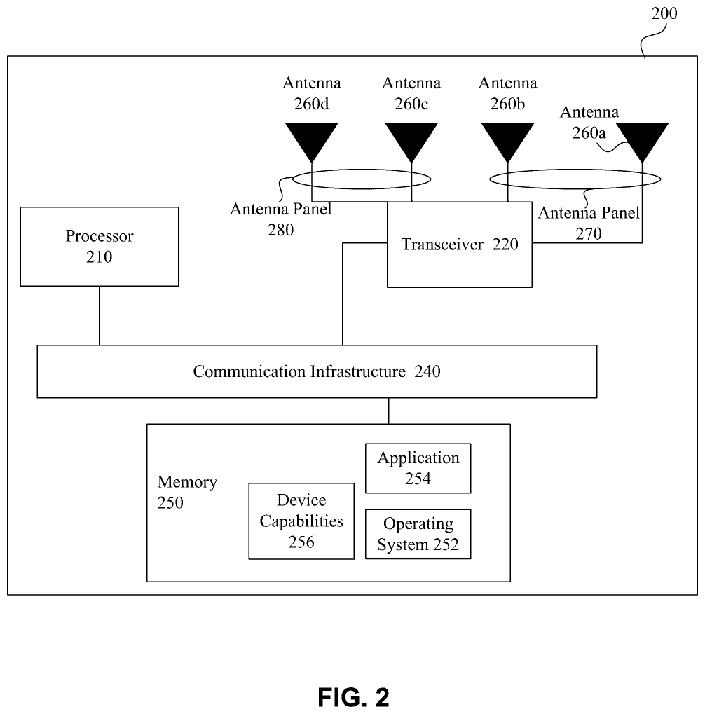

FIG. 2 illustrates a block diagram of an electronic device 200 implementing the transmission power control of a UE, according to some aspects of the disclosure. The electronic device 200 may be any of the electronic devices (e.g., the UE 102 and the base stations 104 and 106) of the system 100. The electronic device 200 includes a processor 210, one or more transceivers 220, a communication infrastructure 240, a memory 250, an operating system 252, an application 254, device capabilities 256, and antennas 260a, 260b, 260c, and 260d. Illustrated systems are provided as exemplary parts of electronic device 200, and electronic device 200 may include other circuit(s) and subsystem(s). Also, although the systems of electronic device 200 are illustrated as separate components, the aspects of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. The applications in the application 254 may include applications such as, but not limited to, radio streaming, video streaming, remote control, and/or other user applications. In some aspects, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for the transmission power control, as described herein. Alternatively, or additionally, the processor 210 can be “hard coded” to implement mechanisms for the transmission power control, as described herein.

The one or more transceivers 220 transmit and receive communications signals support mechanisms for the transmission power control. Additionally, the one or more transceivers 220 transmit and receive communications signals that support mechanisms for measuring communication link(s), generating and transmitting system information, and receiving the system information. According to some aspects, the one or more transceivers 220 may be coupled to the antennas 260a, 260b, 260c and 260d to wirelessly transmit and receive the communication signals, where each antenna 260 has its own transceiver 220, or is grouped with another antenna 260 to share a transceiver 220 according to known power dividing techniques. The antennas 260a, 260b, 260c and 260d may include one or more antennas that may be the same or different types and can form one or more antenna ports. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks. In some aspects, the antennas 260a, 260b, 260c and 260d can correspond to one or more antenna panels. For example, the antennas 260a and 260b can form a first antenna panel 270 and the antennas 260c and 260d can form a second antenna panel 280. In such a scenario, the antennas 260a and 260b may be fed by a first same transceiver 220. Likewise antennas 260b and 260c may be fed a second same transceiver 220, different from the first same transceiver 220 used for antennas 260a and 260b to enable separate gain control. In addition, the first antenna panel and the second antenna panel can correspond to a first beam and a second beam. The first beam can point in a first direction by beamforming the antennas 260a and 260b. Similarly, the second beam can point in a second direction by beamforming the antennas 260c and 260d. In some aspects, the one or more antenna panels may include one or more overlapping antennas. For example, the first antenna panel may include the antennas 260a, 260b, and 260c. The second antenna panel may include the antennas 260b, 260c, and 260d.

According to some aspects of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver.

Additionally, the one or more the transceivers 220 may include one or more circuits (including a cellular transceiver) for connecting to and communicating on cellular networks. The cellular networks may include, but are not limited to, 3G/4G/5G networks such as Universal Mobile Telecommunications System (UMTS), Long-Term Evolution (LTE), and the like. For example, the one or more transceivers 220 may be configured to operate according to one or more of Rel-15, Rel-16, Rel-17, or other releases of 3GPP standard.

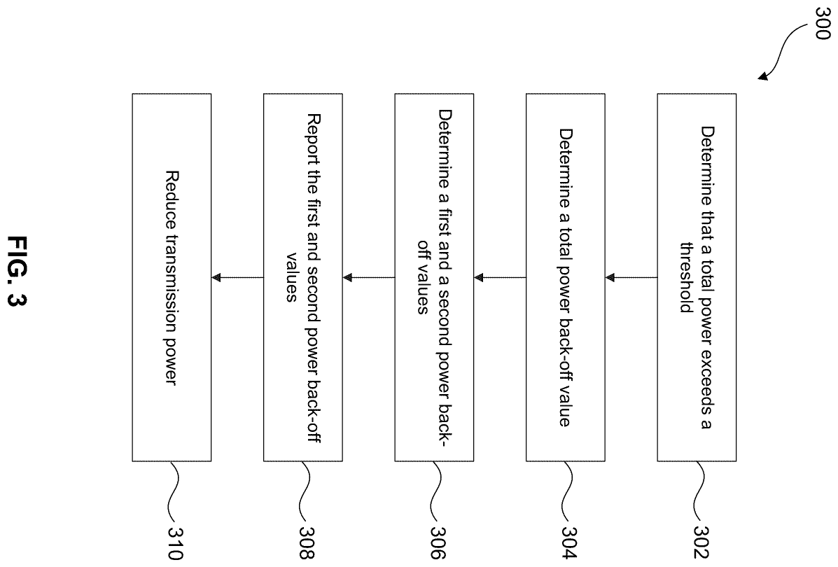

As discussed in more detail below with respect to FIGS. 3-5, processor 210 may implement different mechanisms for the transmission power control as discussed with respect to the system 100 of FIG. 1.

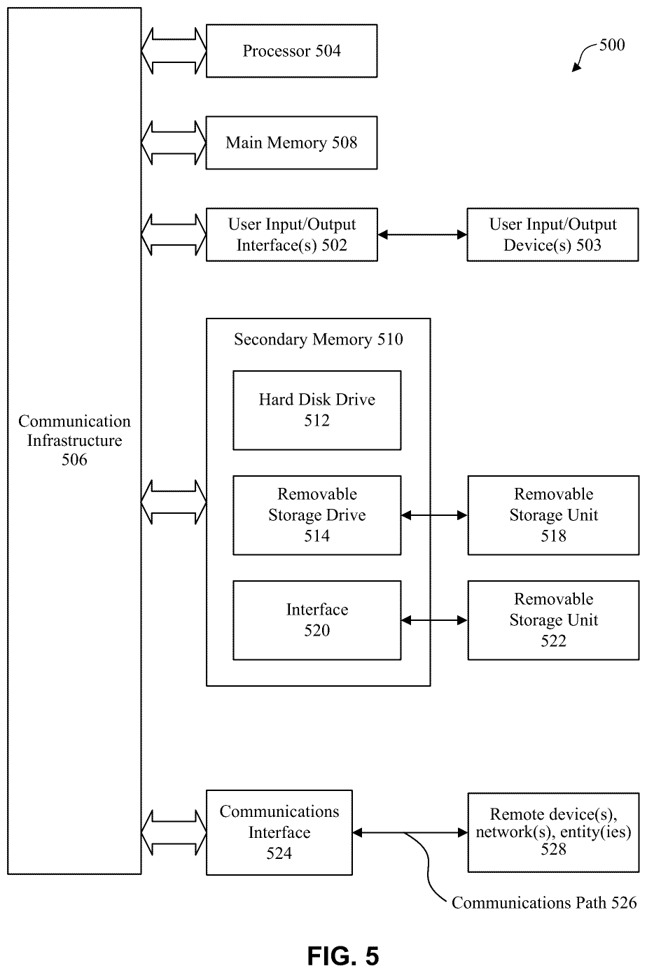

FIG. 3 illustrates an example method 300 of adjusting and reporting the transmission power, according to aspects of the disclosure. The example method 300 is provided for the purpose of illustration only and does not limit the disclosed aspects. As a convenience and not a limitation, FIG. 3 may be described with regard to elements of FIGS. 1, 2, and 5. The example method 300 may represent the operation of electronic devices (for example, the UE 102) implementing the transmission power control. The example method 300 may also be performed by the electronic device 200 of FIG. 2, controlled or implemented by processor 210, and/or computer system 500 of FIG. 5. But the example method 300 is not limited to the specific aspects depicted in those figures and other systems may be used to perform the method, as will be understood by those skilled in the art. It is to be appreciated that not all operations may be needed, and the operations may not be performed in the same order as shown in FIG. 3.

At 302, a UE, such as the UE 102 in FIG. 1, determines that a total transmission power of the first antenna panel and the second antenna panel is greater than a threshold. In some aspects, the threshold can be related to at least three types of restriction situations. First, the restriction situation can be a MPE restriction violation. For example, the UE may be subject to a MPE restriction. Specifically, a PD of signals transmitted by the UE is limited by a MPE threshold value. The MPE threshold value can be provided by regulatory standards or guidelines established by authorities like the Federal Communications Commission (FCC) in the United States or the International Commission on Non-Ionizing Radiation Protection (ICNIRP) internationally. In some aspects, a measuring device can measure the PD of signals transmitted by the UE. The measuring device may be equipped with sensors or probes capable of measuring the electromagnetic fields (EMF) emitted by the UE. The measuring device can be another UE, a base station, or other electronic devices. When the measuring device detects that the PD of signals transmitted by the UE exceeds the MPE threshold value, the measuring device determines that the UE violates the MPE restriction. The measuring device can report the MPE restriction violation to the network and the network can inform the UE regarding the MPE restriction violation via a base station, such as the base station 104 or the base station 106. In some aspects, the measurement device can also report to the UE directly via direct connections, such as a device-to-device (D2D) connection between the UE and the measuring device. In either case, the UE detects the MPE restriction violation via the measuring device. In some aspects, a test lab can include one or more measuring devices to measure the PD of signals transmitted by the UE and determine whether the UE exceeds the MPE threshold. Thus, the one or more measuring device may be lab equipment for testing purposes.

In some aspects, the UE can detect the MPE restriction violation by itself. For example, the UE can determine whether the MPE restriction violation exists based on its transmission signal power and distance to surrounding environment. First, the UE can determine its transmission signal power by monitoring its output power. For example, the UE can monitor its output power amplifier to gather information regarding its transmission signal power. The UE may also include sensors that detect objects and humans around the UE. For example, the UE can determine that a human is three feet away from the UE. In such a case, the UE can estimate strengths of transmitted signals after experiencing three feet propagation and degradation as well as the PD of signals transmitted by the UE in a distance of three feet. In addition, the UE may include multiple antenna panels. In such a case, the UE needs to consider signals transmitted by each of the multiple antenna panels.

Second, the restriction situation can be a total EIRP restriction violation. For example, the UE may be subject to a total EIRP restriction in a restricted direction. Specifically, radiation of the UE in the restricted direction is limited by an EIRP value. Similar to the MPE restriction situation discussed above, the UE can detect the total EIRP restriction violation via the measuring device or by itself. Specifically, the measuring device can measure radiation levels from the UE in the restricted direction and determine whether the UE violates the total EIRP restriction. The UE can also determine its transmission power in the restricted direction. For example, the UE can estimate by determining the power levels that are supplied to its antennas, antenna gains, losses in transmission chains of the UE, beamforming directions, and other factors. Based on its transmission power in the restricted direction, the UE can determine whether the total EIRP restriction is violated.

Third, the restriction situation can be a total radiated power restriction violation. For example, the UE may be subject to a total radiated power restriction. Specifically, the transmission power of all antennas or all antenna panels is subjected to a total radiated power restriction regardless of directions. For example, antennas of the UE may form one or more antenna panels that are used to transmit to one or more base stations. The one or more antenna panels are beamformed to different directions that may or may not overlap. Nevertheless, total power of signals transmitted from the one or more antenna panels is limited by a total radiated power limitation. Similar to the above discussions, surrounding devices, such as the measuring device and other devices, can measure the total power of the UE and report to the UE when the UE violates the total power restriction. The UE can also estimate the total power by itself and determine whether the total power restriction is violated.

At 304, the UE determines a total power back-off value. In some aspects, when the UE detects the restriction situation, the UE also determines an excess power that is above the restriction. For example, when the UE violates the MPE restriction, the UE determines the amount of the excess power by comparing the PD of the UE and the MPE threshold value. For another example, when the UE violates the total EIRP restriction, the UE can determine the amount of the excess power by comparing its transmission power in the restricted direction and the total EIRP restriction. For yet another example, when the UE violates the total radiated power restriction, the UE can determine the amount of the excess power by comparing its total transmission power and the total radiated power limitation. In any case above, the UE can determine the total power back-off value based on the excess power. For example, the total power back-off value can be the same as the amount of the excess power if the restriction is the MPE restriction or the total radiated power restriction. When the restriction is the total EIRP restriction, the UE can consider directions of signals transmitted by the UE and the restricted direction. If the directions of signals transmitted fully overlap with the restricted direction, the total power back-off value can be the same as the amount of the excess power. Otherwise, the total power back-off value can be adjusted based on a percentage of overlap between the directions of signals and the restricted direction.

In some aspects, the UE can also determine and/or adjust the total power back-off value based on an overlapping condition between the first antenna panel and the second antenna panel. For example, the first antenna panel can correspond to a first beam and the second antenna panel can correspond to a second beam. If the first beam largely overlaps with the second beam, the UE can determine the total power back-off value to be large or increase the total power back-off value. This is because when the first beam severely overlaps with the second beam, it is likely that both the first antenna panel and the second antenna panel contribute to the total transmission power that exceeds a restriction. For example, when the first beam and the second beam overlaps in a direction, signals transmitted from both the first antenna panel and the second antenna panel contribute to the power density in the overlapping direction. In some aspects, the UE can determine a level of overlapping in at least two approaches. First, the UE can determine based on signal-to-interference-plus-noise ratio (SINR) of signals received by the first antenna panel or the second antenna panel. If the SINR is high or higher than a SINR threshold, it means that the first and the second beams of the first and the second antenna panels are well isolated and the level of overlapping is low. In such a case, the UE can determine that the total power back-off value to be small or decrease the total power back-off value. Otherwise, the first and the second beams are not well isolated and the level of overlapping is high. In such a case, the UE can determine that the total power back-off value to be large or increase the total power back-off value. In some aspects, the total power back-off value or an adjustment of the total power back-off value can be inversely proportional to the SINR. Thus, the UE can calculate or adjust the total power value based on the SINR. Second, the UE can determine the level of overlapping based on an angle of departure (AoD) of the first and the second antenna panels. Specifically, the AoD can indicate an angle between the first beam and the second beam. If the AoD is large or larger than a threshold angle, the first and the second beams are well isolated and the level of overlapping is low. In such a case, the UE can determine that the total power back-off value to be small or decrease the total power back-off value. Otherwise, the first and the second antenna panels are not well isolated and the level of overlapping is high.

In such a case, the UE can determine that the total power back-off value to be large or increase the total power back-off value. In some aspects, the total power back-off value or an adjustment of the total power back-off value can be inversely proportional to the AoD. Thus, the UE can calculate or adjust the total power value based on the AoD. In some aspects, the AoD can be provided by the network. For example, the network may transmit a configuration message or a report to the UE via a base station, wherein the configuration message or the report can indicate the AoD.

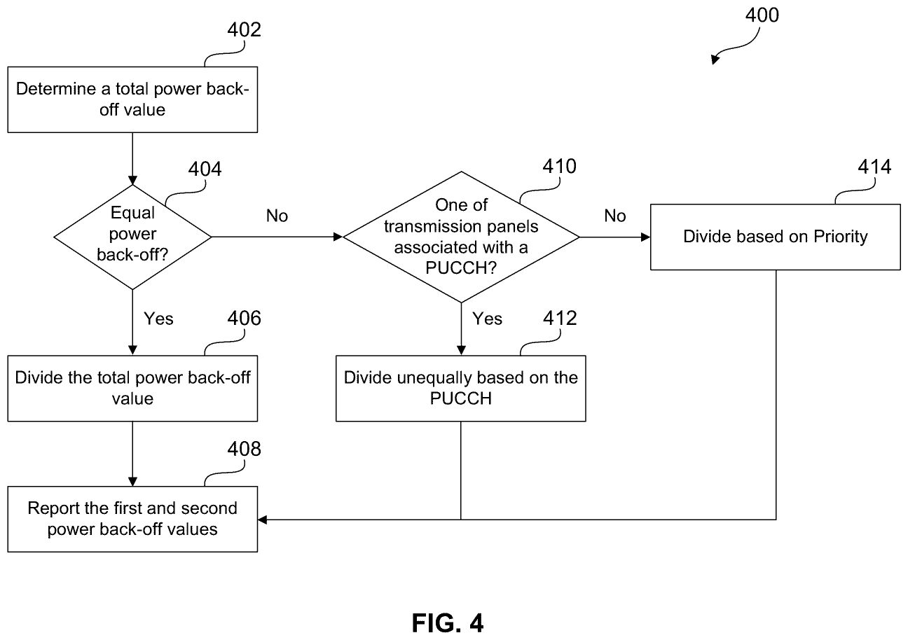

At 306, the UE determines a first power back-off value and a second power back-off value. In some aspects, the UE includes a first antenna panel and a second antenna panel. In such a case, both the first and the second antenna panels may contribute to the restriction violation discussed above. The UE can reduce transmission power of the first antenna panel by the first power back-off value and reduce transmission power of the second antenna panel by the second power back-off value. In some aspects, the UE determines the first and the second power back-off values based on the total power back-off value. More details regarding back off power determination are discussed below in FIG. 4.

At 308, the UE reports the first and the second power back-off values to the network and/or base stations. In some aspects, the UE reports the first and the second power back-off values via separate PHRs. For example, the UE can generate a first PHR that indicates the first power back-off value for the first antenna panel and generate a second PHR that indicates the second power back-off value for the second antenna panel. The UE can then transmit the first PHR via the first antenna panel to a first base station, such as the base station 104 of FIG. 1. The UE can also transmit the second PHR via the second antenna panel to a second base station, such as the base station 106 of FIG. 1.

For another example, the UE can generate a combined PHR that indicate both of the first power back-off value and the second power back-off value. In some aspects, the combined PHR can include a reserved bit “R.” The UE can set the reserved bit to 1 to indicate that the combined PHR includes information for multiple base stations, instead for information of multiple cells. The UE can transmit the combined PHR via the first antenna panel to a first base station or via the second antenna panel to a second base station. In some aspects, the network can configure the UE, via the first base station or the second base station, to transmit the combined PHR to the first base station or the second base station. For example, the first base station or the second base station can generate a configuration message that indicates whether to transmit the combined PHR to the first base station or the second base station and transmit the configuration message to the UE. The network can also configure the UE, via the first base station or the second base station, to transmit the combined PHR based on link conditions of a set of communication links. For example, the UE connects with the first base station via a first communication link, such as the communication link 108 and connects with the second base station via a second communication link, such as the communication link 110. The configuration message may configure the UE to transmit the combined PHR using a link selected from one of the first and the second communication links that has a higher downlink (DL) reference signal received power (RSRP). In such a case, the UE can measure DL signals and determine a link to transmit the combined PHR. For example, the UE may determine that the DL signals received from the first communication link 108 have a higher DL RSRP. The UE can then transmit the combined PHR via the first communication link 108 using the first antenna panel to the first base station 104.

In some aspects, the UE also determines when to transmit PHRs, such as the separate PHRs or the combined PHR. In some aspects, the UE can transmit the PHRs based on a phr-PeriodicTimer, which is configured by the network. For example, when the phr-PeriodicTimer expires, the UE can transmit the PHRs. In other aspects, the UE can transmit the PHRs based on a phr-ProhibitTimer and a phr-Tx-PowerFactorChange value, which are also configured by the network. The phr-Tx-PowerFactorChange values represents a threshold change in the communication link, such as threshold change in the path loss condition. For example, the UE may determine that the phr-ProhibitTimer has expired and the path loss condition has changed more than the phr-Tx-PowerFactorChange value. In such a case, the UE can transmit the PHRs. However, if the phr-ProhibitTimer is not expired or the path loss condition has not changed more the phr-Tx-PowerFactorChange value, the UE does not transmit the PHRs.

In some aspects, the network can configure different types of devices differently. For example, fixed wireless access (FWA) device and customer premises equipment (CPE) may have higher transmission power than handheld devices. Thus, when configuring the FWA device or the CPE device, the network can set phr-ProhibitTimer to a shorter period and/or phr-Tx-PowerFactorChange to a smaller value compared with phr-ProhibitTimer and the phr-Tx-PowerFactorChange of handheld devices. In yet other aspects, the network can configure the UE to report the PHRs immediately after the UE detects the restriction situation and determines the first and the second power back-off values. For example, the UE can transmit the PHRs in a time location that is possible for PHR transmission immediately following detecting the restriction situation and determining the first and the second power back-off values.

At 310, the UE reduces transmission power of the first and the second antenna panels. For example, the UE can reduce transmission power of the first antenna panel by the first power back-off value and reduce transmission power of the second antenna panel by the second power back-off value. In aspects, the transmission power is reduced by reducing amplifier gain in the transceiver serving the respective antenna panel.

FIG. 4 illustrates an example method 400 of assigning power reduction to multiple panels of the UE, according to aspects of the disclosure. The example method 400 is provided for the purpose of illustration only and does not limit the disclosed aspects. As a convenience and not a limitation, FIG. 4 may be described with regard to elements of FIGS. 1, 2, and 5. The example method 400 may represent the operation of electronic devices (for example, the UE 102) implementing the transmission power control. The example method 400 may also be performed by the electronic device 200 of FIG. 2, controlled or implemented by processor 210, and/or computer system 500 of FIG. 5. But the example method 400 is not limited to the specific aspects depicted in those figures and other systems may be used to perform the method, as will be understood by those skilled in the art. It is to be appreciated that not all operations may be needed, and the operations may not be performed in the same order as shown in FIG. 4.

At 402, a UE, such as the UE 102 in FIG. 1, determines a total power back-off value, as discussed in 304 of FIG. 3. In some aspects, the total power back-off value can be based on a MPE restriction, a total EIRP restriction, or a total radiated power restriction.

At 404, the UE determines whether to perform equal power back-off. In some aspects, the UE may determine to reduce transmission power equally amongst antenna panels of the UE. For example, the UE may include a first antenna panel and a second antenna panel. The UE can reduce half of the total power back-off value for each of the first and the second antenna panels. The equal power back-off strategy may maintain communication links corresponding to both the first and the second antenna panels. For example, transmission power of the first and the second antenna panels may be XI dBm and X₂ dBm respectively. The total power back-off value may be A dBm. Assuming that the UE can maintain communication links of the first and the second antenna panels if their transmission power levels are no less than X₁-A/2 dBm and X₂-A/2 dBm respectively, reducing the transmission power of both the first and the second antenna panels by A/2 dBm can maintain the communication links of both the first and the second antenna panels. Thus, the equal power back-off strategy can maintain the communication links of both the first and the second antenna panels in certain scenarios. In other words, the UE can determine to perform the equal power back-off strategy when the communication links of the first and the second antenna panels can be maintained by reducing transmission power equally. However, in other scenarios, the UE may not be able to maintain both communication links using equal power back-off. In another example, the total power back-off value is 2A dBm instead of A dBm. In such a case, the equal power back-off strategy may cause both communication links to fail. In such a case, the UE may determine to perform unequally power back-off. For example, the UE can reduce transmission power of the first antenna panel by 2A dBm and the transmission power of the second antenna panel remains unchanged. Thus, the communication link of the second antenna panel is not impacted so that the UE can still communicate with a base station in the network. In summary, the UE can determine whether to perform the equal power back-off based on the total power back-off value and minimal transmission power required for each antenna panel to maintain its communication link. In other aspects, the equal power back-off strategy can be a default option. For example, when the UE does not have enough information to determine the minimum transmission power needed to maintain the communication link for each antenna panel, or the UE does not have computational resources or time resources to determine whether it is possible to maintain both communication links, the UE can perform the equal power back-off. In any case, if the UE determines to perform the equal power back-off, the control moves to 406.

At 406, the UE divides the total power back-off value amongst antenna panels of the UE. For example, when the total power back-off value is A dBm and the UE includes the first and the second antenna panels, the UE can set both a first power back-off value and a second power back-off value to A/2 dBm.

At 408, the UE reports the first and the second power back-off values to a base station or the network, as discussed in 308 of FIG. 3. The UE then reduces transmission power of the first and the second antenna panels, as discussed in 310 of FIG. 3.

Referring back to 404, if the UE determines to perform unequal power back-off, the control moves to 410.

At 410, the UE determines whether one of antenna panels of the UE is associated with a physical uplink control channel (PUCCH). For example, the first antenna panel may be used to transmit signals in the PUCCH to a base station. While the second antenna panel may be used to transmit signals in a physical uplink shared channel (PUSCH). In such a case, the control moves to 412.

At 412, the UE proportions the total power back-off value unequally between the first antenna panel and the second antenna panel to lessen the power reduction of the antenna panel serving the PUCCH. For example, the first antenna panel can be associated with the PUCCH and its current transmission power is X₁ dBm. To maintain the PUCCH, the first antenna panel needs to have at least X₁-A/2 dBm transmission power. In such a case, the UE can reduce the transmission power of the first antenna panel by A/2 dBm or less. The UE then assigns the remaining of the total power back-off to the second antenna panel. Thus, if the total power back-off value is 2A dBm, the first power back-off value is A/2 dBm and the second power back-off value is 3A/2 dBm, thereby setting the transmission power reduction to favor the PUCCH served by the first antenna panel. The control then moves to 408 and the UE reports the first and the second power back-off values.

Referring back to 410, if the UE determines that neither or both of the first and the second antenna panels are associated with a PUCCH, the control moves to 414.

At 414, the UE can divide the total power back-off value based on priority values. For example, the first antenna panel corresponds to a first priority value and the second antenna panel corresponds to a second priority value. The first priority value may be higher than the second priority value and thus the first antenna panel has a higher priority. In such a case, the UE can reduce the transmission power less for the first antenna panel compared with the second antenna panel. For example, the UE can proportion the transmission power reduction similarly as discussed in 412 to main the communication link of the first antenna panel. For another example, the UE can divide the total power back-off value by a ratio between the first and the second antenna panels. The ratio can be predefined or calculated based on the first and the second priority values. For example, if the first priority is 2 and the second priority is 1, the ratio can be 1 to 2, where the UE reduces transmission power of the second antenna panel twice as much as the first antenna panel. The control then moves to 408 and the UE reports the first and the second back-off values.

Various aspects can be implemented, for example, using one or more computer systems, such as computer system 500 shown in FIG. 5. Computer system 500 can be any well-known computer capable of performing the functions described herein such as the UE 102 and the base station 104 of FIG. 1. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

The operations in the preceding aspects may be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE) comprising:
a first antenna panel and a second antenna panel to enable wireless communication with a first base station and a second base station respectively; and
a processor, communicatively coupled to the first antenna panel and the second antenna panel, and configured to:
determine that a total transmission power of the first antenna panel and the second antenna panel is greater than a threshold;
determine a first back-off value for the first antenna panel and a second back-off value for the second antenna panel;
generate a report that indicates the first back-off value and the second back-off value; and
transmit, via the first antenna panel or the second antenna panel, the report.

2. The UE of claim 1, wherein the processor is further configured to:
reduce a transmission power of the first antenna panel based on the first back-off value; and
reduce a transmission power of the second antenna panel based on the second back-off value.

3. The UE of claim 1, wherein the threshold includes a maximum permissible exposure (MPE) threshold value, an effective isotropic radiated power (EIRP) value, or a total radiated power limitation.

4. The UE of claim 1, wherein the second back-off value is equal to the first back-off value.

5. The UE of claim 1, wherein the second back-off value is greater than the first back-off value.

6. The UE of claim 5, wherein the processor is further configured to:
determine that the first antenna panel is associated with a Physical Uplink Control Channel (PUCCH); or
determine that a priority of the first antenna panel is higher than a priority of the second antenna panel.

7. The UE of claim 1, wherein the processor is further configured to determine the total transmission power by:
determining a signal-to-interference-plus-noise ratio (SINR) of a downlink associated with the first antenna panel or the second antenna panel; and
determining the total transmission power based on the SINR.

8. The UE of claim 1, wherein the processor is further configured to determine the total transmission power by:
determining an angle of departure (AoD) of the UE; and
determine the total transmission power based on the AoD.

9. The UE of claim 1,
wherein the report is a power headroom report (PHR),
wherein the PHR include a reserved bit, and
wherein the reserved bit is set to 1 to indicate that the PHR is for multiple base stations.

10. The UE of claim 1, wherein the processor is further configured to transmit the report in response to determining that the total transmission power of the first antenna panel and the second antenna panel is greater than the threshold.

11. A method of a user equipment (UE) comprising:
determining that a total transmission power of a first antenna panel and a second antenna panel of the UE is greater than a threshold;
determining a first back-off value for the first antenna panel and a second back-off value for the second antenna panel;
generating a report that indicates the first back-off value and the second back-off value; and
transmitting, via the first antenna panel or the second antenna panel, the report.

12. The method of claim 11, further comprising
reducing a transmission power of the first antenna panel based on the first back-off value; and
reducing a transmission power of the second antenna panel based on the second back-off value.

13. The method of claim 11, wherein the threshold includes a maximum permissible exposure (MPE) threshold value, an effective isotropic radiated power (EIRP) value, or a total radiated power limitation.

14. The method of claim 11, wherein the first back-off value is equal to the second back-off value.

15. The method of claim 11, wherein the first back-off value is greater than the second back-off value.

16. The method of claim 15, further comprising:
determining that the second antenna panel is associated with a Physical Uplink Control Channel (PUCCH); or
determining that a priority of the second antenna panel is higher than a priority of the first antenna panel.

17. The method of claim 11,
wherein the report is a power headroom report (PHR),
wherein the PHR include a reserved bit, and
wherein the reserved bit is set to 1 to indicate that the PHR is for multiple base stations.

18. The method of claim 11, further comprising:
transmitting the report in response to determining that the total transmission power of the first antenna panel and the second antenna panel is greater than the threshold.

19. A non-transitory computer-readable medium (CRM) comprising instructions to, upon execution of the instructions by one or more processors of a user equipment (UE), cause the UE to perform operations, the operations comprising:
determining that a total transmission power of a first antenna panel and a second antenna panel of the UE is greater than a threshold;
determining a first back-off value for the first antenna panel and a second back-off value for the second antenna panel;
generating a report that indicates the first back-off value and the second back-off value; and
transmitting, via the first antenna panel or the second antenna panel, the report.

20. The non-transitory CRM of claim 19, wherein the threshold includes a maximum permissible exposure (MPE) threshold value, an effective isotropic radiated power (EIRP) value, or a total radiated power limitation.
